(19) United States
(12) Patent Application Publication
(10) Pub. No.: US 2026/0123787 A1
(43) Pub. Date: May 7, 2026

(54) Splatter Control Apparatus with Tension Member

(71) Applicant: Alex Kheder, Anaheim, CA (US)

(72) Inventor: Alex Kheder, Anaheim, CA (US)

(21) Appl. No.: 19/439,321

(22) Filed: Jan. 3, 2026

Related U.S. Application Data
(63) Continuation of application No. 16/737,916, filed on Jan. 9, 2020, now abandoned.
(60) Provisional application No. 62/790,377, filed on Jan. 9, 2019.

(51) Int. Cl. A47J 36/06

(52) U.S. Cl. CPC A47J 36/064

(57) ABSTRACT

A splatter control apparatus for use with a cooking vessel lid is disclosed. The apparatus includes a flexible, elastically deformable tension member configured to be compressed for insertion along an inner side of a frame of the lid and to expand outwardly upon release. An absorbent sleeve member is disposed circumferentially about the tension member and is urged into continuous contacting relation with the inner side of the lid by the expansion force of the tension member. The absorbent sleeve intercepts and absorbs grease and condensed moisture migrating along an inner surface of the lid during cooking. In alternative embodiments, the absorbent sleeve is removable and replaceable, or the apparatus is formed as an integrated, fully disposable absorbent member combining tension and absorbent properties.

### CROSS-REFERENCE TO RELATED APPLICATIONS

This application claims the benefit of U.S. Non-Provisional patent application Ser. No. 16/737,916 filed on Jan. 9, 2020, which is incorporated by reference herein in its entirety. This application claims the benefit of U.S. Provisional Patent Application No. 62/790,377, filed Jan. 9, 2019, which is incorporated by reference herein in its entirety.

### SPECIFICATION

### BACKGROUND OF THE INVENTION

### (1) Field of the Invention

The present invention relates to splatter control in one common field is in the kitchen accessories and relates particularly to a splatter control covering device for cooking vessels. More specifically, this invention relates to a replaceable, removable and disposable member splatter control device to be used with utensils and cookware.

### (2) Description of Related Art Including Information Disclosed

It is commonly known that frying, searing or simmering foods on a stovetop can be a messy process, even for an experienced cook. Food liquids, oil and grease often splatter outside the pot, or cooking utensils and onto the surrounding areas of the stove, counter tops and walls. Such splattering materials not only create unsanitary, unsightly mess on the stove, counter tops, walls and surrounding surfaces, but also produce an undue safety hazard to persons, further it creates fire hazard due to grease buildup. The splattering of grease from inside a cooking utensil can not only cause severe burns to people, but also increases the likelihood of kitchen grease fires. Statistics in 2017 reveal that nearly 5,000,000 cooking fires occur annually in the home, of these fires, grease fires are the most dangerous and are responsible for 1 in every 5 home fire deaths. In light of these challenges, many devices currently available to control splattering include: metal covers or mesh covers which are placed over the vessel or food item being prepared; plastic covers and absorbent papers, aluminum foil and parchment paper. None of these devices, however, combine all the attributes of being disposable, universally adaptable to all of the major cooking settings and capable of maintaining a cooking environment suitable for all cooking types, and yet simple to use during cooking. Although some prior art is capable of preventing splatter of cooking liquids still have several disadvantages, some of which are relatively expensive, and are difficult to clean.

An example of such splatter guard devices can be found in:

U.S. Pat. No. 2,999,559 teaches the use of a disposable disc made out of fibrous material in conjunction with a metal ring. Although the top disc is disposable, the metal ring is bulky and hinders access to food therefore may be a cause of burning, not easy to store and still requires cleaning. U.S. Pat. No. 2,686,608 teaches the use of a cylindrical guard made out of disposable paper that sits inside a frying vessel and includes vents to allow air circulation. However, it is open at the top and does not entirely prevent the splatter.

U.S. Pat. No. 9,655,471 B2 is a disposable non-absorbent rigid covering, causes moisture condensation and prohibitively high cost. U.S. Pat. No. 9,492,029 B2 is a tongue like devise that clamps onto the reference is impractical specially as the paper gets damp it wilts down into the cooking vessel. DE 102010001163 is a circular frame that clamps onto a paper using struts with a pivot access and a fastening means, the many moving parts and fastening means render the design impractical.

Clearly there is a need for a tried and tested splatter control method that combines the convenience of being disposable, affordable, simple and safe to use, eliminate splatter, reduce cooking odor, prevent grease fires, prevent injuries, being generally heat and flame-resistant, can be permeable to offer preferred cooking results and is versatile enough to be used with any common cooking methods and vessels.

### BRIEF SUMMARY OF THE INVENTION

The principal aim of the invention herein is to provide a safe splatter control apparatus that prevents splatter of grease and liquids during cooking operations that is versatile enough to be used with virtually many cooking vessels and methods.

Another aim of the invention herein is to provide a splatter control apparatus with the advantages of being efficient, practical, economical, safe and easy to handle with a replaceable element that may have an activated carbon feature that absorbs odors, be absorbent or non-absorbent, porous or non-porous, paper related, fabric related, silicon, mesh screen material or a combination of multi materials thereof.

These and other objects are addressed by the present invention, directed to a splatter control apparatus comprising a flexible tension member configured to opportunely secure into a frame member, a frame member suitable to rest on top edge of a cooking vessel with a splatter member that can be secured between the tension ring member and the frame member thereby controlling the moisture and oil splatter.

More particularly, the present invention is directed to a splatter control apparatus comprising a flexible tension ring member utilized from the inner side of a frame member, the inner side of the frame member configured to cradle the flexible tension ring member, a flat sheet member thereafter is secured between the tension ring member and the frame member, a handle member is coupled to the frame as needed, Support elements such as ribs are added to the bottom edge of the frame member to permit it to rest on top of various shape and size vessels.

In one preferred embodiment, a flexible tension ring member is configured to be secured snuggly into the inner side of a frame member, a replaceable flat sheet member suited to be provisionally secured between the frame member and the flexible tension ring member, the ring member is of a flexible tension characteristic when compressed it builds tension, upon being decompressed it restore its tension thereby can be secured into the inner side of the frame member, and hence the flat sheet member is secured in between the ring and the frame.

Protruding means extend properly and proximately at predetermined points of the edges of the ring member to enable manipulating it into and out of the frame member.

In another embodiment, a flexible tension ring member is being enveloped by a sleeve of replaceable disposable absorbent material member configured to be manipulated to be secured into the inner side of a frame of a lid for a cooking vessel, thereafter the absorbent material performs as a splatter control. Furthermore, the tension ring may be of a disposable material, where the combination of disposable tension ring and disposable sleeve member perform as a complete disposable splatter control apparatus. Such economically convenient device can ideally serve both personal and commercial needs.

In another preferred embodiment, having a flexible tension ring member, a frame member, a replaceable and disposable flat sheet member, the inner side of the frame configured to cradle the flexible tension ring, the flexible ring member configured to compress to secure into the inner side of the frame member, The ring member is opportunely coupled to the frame member to swing about the coupling in and out of the frame member; the ring is decompressed to pull out of the frame, a flat sheet member is placed between the ring and the frame, then the ring is compressed over the flat sheet that placed between the ring and the frame into the frame. and plurality of protrusions may extend from the outer edge of the ring member to create stronger gripping function over the replaceable flat sheet, also protruding nips properly and proximately extend of the ring member to manipulate the compression of the ring member to manipulate in and out of the inner side of the frame member. Supporting elements such as ribs are proximately coupled to the bottom edge of the frame member to allow it to rest on top of various size cooking vessels. The flat sheet member may be of one or combined materials such as paper related, fabric related, silicon related, bamboo related, porous material, non-porous material, screen mesh. The flat sheet member can easily be disposed of after cooking therefore eliminating the cumbersome need to clean the apparatus. The splatter control apparatus can be temporarily or permanently coupled to the rim of a vessel as a substitution of or a alongside a handle to manipulate lifting and moving the apparatus. The flat sheet and sleeve members can be configured to have carbon activated characteristics that help absorb cooking odors.

### BRIEF DESCRIPTION OF THE VIEWS OF THE DRAWINGS

FIG. 1-is an apparatus showing a tension member

FIG. 2A is an embodiment showing a tension member enveloped by a sleeve.

FIG. 2B is an embodiment showing a tension member enveloped by a sleeve.

FIG. 3A showing an enveloped tension member with a frame.

FIG. 3B showing a tension member securing a flat member with a frame.

FIG. 4 showing alternate options for the tension member.

FIG. 5 showing an embodiment of a tension member with a flat member into a frame member.

FIG. 6 showing an embodiment of a tension member with a flat member into a frame member with arcs.

### DETAILED DESCRIPTION OF THE INVENTION

The invention herein relates to a cooking utensil with replaceable and disposable element that can be universally utilized in almost any cooking method to eliminate the challenge caused by splattering of grease and cooking liquids. In its broadest form, the utensil is made of a flexible tension member, a frame suited to cradle the flexible tension member and a splatter control means such a flat sheet or a sleeve member which can be secured between the flexible ring member and the frame member. A utensil that is versatile enough be used in a multitude of different cooking environments and can be dimensioned to fit a wide variety of cooking vessel shapes and sizes. The utensil may include a handle for lifting and repositioning of the utensil, and may include supporting elements in the form of ribs substantially positioned to rest it on top rim of various size vessels. When an absorbent porous element used as the splatter control, and when the utensil is rested directly on top of a cooking vessel, this results in minimal oil and grease splatter also enables cooking in a manner similar to that in which it would occur without a cover, rendering it suitable for frying, searing and sautéing operations.

The splatter control means depicted as flat sheet member or sleeve member can be made from paper related material, fabric related, silicon related, bamboo related, porous or non-porous, screen mesh or a combination thereof for different embodiments.

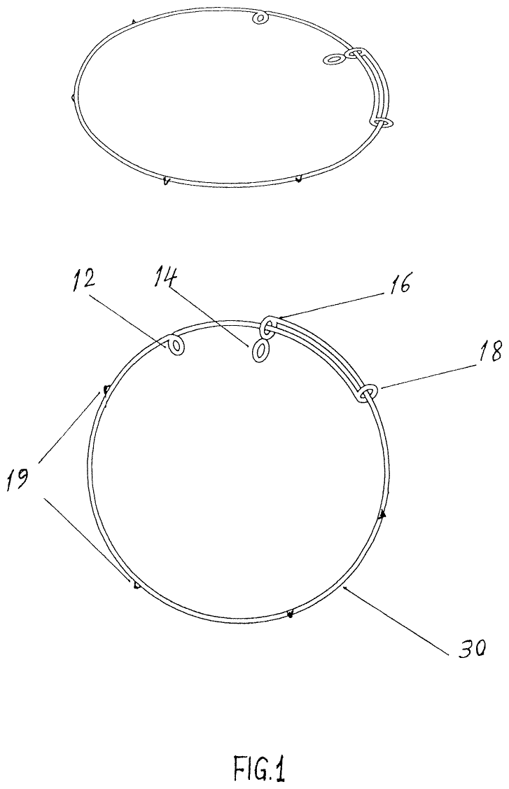

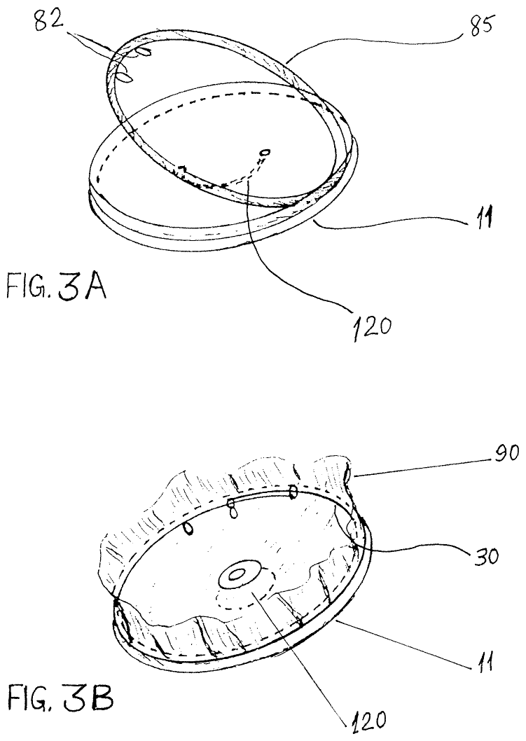

One embodiment of the splatter control Apparatus is illustrated in FIG. 1. for purpose of illustration, shows the present invention is preferentially embodied in an approximately circular shape tension ring member 30, comprises a structure of a flexible tension type material with ends 16 and 18 opportunely flexible to operate with two protruding means 12 and 14 positioned at a predetermined proximate location near the ends, 14 is proximate to the end 16 and 12 is proximate to the end 18, when 12 and 14 are compressed closer, relative to one another, the ring member 30 builds up tension, thereafter releasing the knobs 12 and 14 decompress the built up tension in the flexible ring. The flexible ring is made to be secured into the inner side of a frame of a lid 11, a flat sheet member 90 shown in FIG. 3B being placed between the tension ring member 30 and the inner side of the frame member of a lid 11, where generally the frame member 11 can be a lid for a cooking vessel. Plurality of protrusions 19 may extend of the outer edge of the ring member 30 at predetermined positions to improve securing the ring 30 and the flat sheet 90 into the inner side of a frame member if needed. A handle used for lifting the lid shown as 120 in FIG. 3B the tension ring member 30 made to secure the flat sheet member 90 inside the frame member 11 without the need for clips, screws, bolts or any attaching mechanism. The ring tension compression motion of 12 and 14 and subsequently the ends 16 and 18, relative to one another, shown in FIG. 1. is the only action required in order to replace the flat sheet member 90 during or after use.

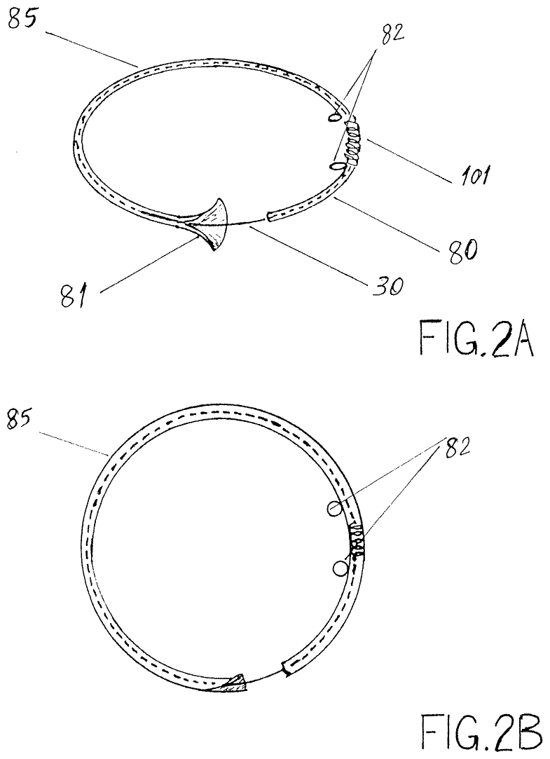

FIG. 2A shows an apparatus 85 comprising a flexible tension ring member 30 being enveloped by a sleeve member of disposable absorbent means 80, the apparatus 85 configured to be manipulated to be secured into the inner side of a frame of a lid 11 of a cooking vessel as shown in FIG. 3A. The ring member comprises a tension member 30 with suitable compression mechanism 101, the sleeve member 80 offers a side opening 81 or the like that allow the sleeve 80 to slip over the ring member 30 to envelope said tension ring member, and hence said ring 30 and sleeve 80 combination form a device 85 being an absorbent splatter control means when secured inside a lid 11 as shown in FIG. 3A.

Further, the flexible ring member 30 may be made of a disposable flexible type tension material with all other elements and features of the apparatus 85 being the same, the combination of a disposable ring member 30 and disposable sleeve member 80 perform as comprehensive replaceable and disposable splatter device 85 FIG. 2A. The physical state of the flexible ring member 30 can be elastically adaptable, opportunely and proximately enough to be placed properly and snuggly into the inner side of a frame of a lid 11 for a vessel. FIG. 3A.

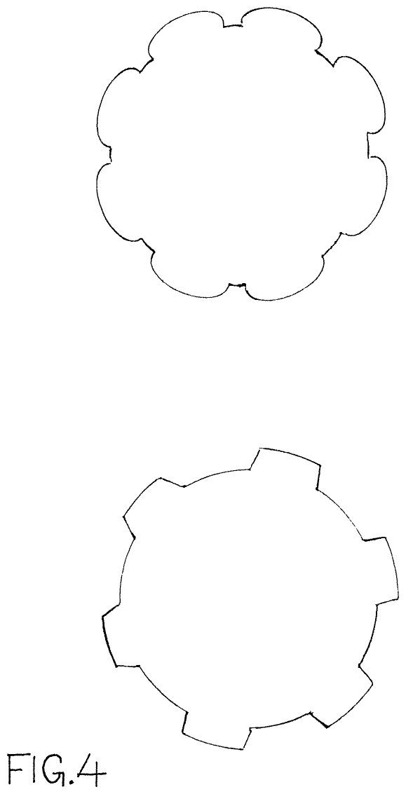

FIG. 3B shows the flat sheet member 90 secured between the ring member 30 and the frame member of a lid 11, where the flat sheet member 90 being made of an absorbent porous material therefore acts as splatter control means inside the lid to prevent grease and oil splatter, also stops the condensed moisture on the undersurface of the lid 11 from dripping over the hot oil or hot pan, and hence eliminating splatter and keeping the integrity and quality of cooked food. For safer handling 12 and 14 can be covered with protective insulating material as required. The flat sheet 90 is easily discarded creating minimal waste meanwhile replaced quickly with a new flat sheet member after the cooking process. When the ring member 30 with the flat sheet 90 secured therein into a lid 11, then the lid is properly placed on top edge of an appropriate cooking vessel. In various designs, and as it may be required, the protruding elements 12 and 14 may extend properly and proximately at predetermined position being the ends of a ring member 30 to manipulate the compression motion. FIG. 2A. shows the ring member 30 can be made with the protruding means 12 and 14 being the ends of the ring member 30 as a substitute for the overlapping mechanism formed by 16 and 18 shown in FIG. 1, this modification of 12 and 14 as ends of the member provides another option of compression mechanism design and a simpler method of manufacturing. The tension ring member can vary is shape, size and design with no limitations, two examples are shown in FIG. 4.

To place the apparatus 85 into the lid member 11, the ring is compressed by the mechanism 101 utilizing the means 82 FIG. 2 the compression released after placing the apparatus 85 inside the lid 11, thereafter the released compression of the ring member 30 will secure the apparatus 85 inside the lid 11 FIG. 3A during the cooking process, subsequently the moisture and splatter produced from cooked foods that is generally condensed on the undersurface of the lid 11 will gradually slither of the curved surface of the lid 11 to its perimeter where the absorbent sleeve 80 of the apparatus 85 is placed, consequently the disposable apparatus 85 soaks up the grease and moisture mixture and stop any from dripping back over the frying or cooking foods FIG. 3A. The disposable ring member can be made of any elastic material adaptable to fit into a lid through any familiar compression mechanism without limitations, the compression mechanism is achieved through bending, twisting, spiraling, squeezing, overlapping, O-ring compression, or the like.

This apparatus 85 can be made in variable design options, one option that comprises a tension ring member 30 being made of sustainable material means to be reused indefinitely such as metal related, plastic related, silicon related, wood related or the like along with a replaceable disposable sleeve member 80. a second option being of a tension ring member 30 made of disposable material along with a disposable sleeve member 80 to create a complete disposable apparatus 85 as shown in FIG. 2. Both options provide a variation of disposable splatter control element that is environmentally friendly and is ideal for use in the travel, hospitality, home or commercial settings with minimal waste. The ring member 30 can be made from a proper material paper related, wood related, bamboo related, metal related, plastic related, silicon related or the like. The apparatus 85 offer a friendly convenient affordable method of splatter control to maintain clean area during cooking while creating the quality foods desired, other features include convenient transport and storage. This novel disposable sleeve ring apparatus 85 can be produced in individual predetermined size ring members made for specific lid measurements, or may be produced in bulk format such as a role or a stack format that may be dispensed in predetermined pre-scored segments that match the desired size to conform to the lid size being used, the bulk format will provide new possibilities for use with any size and shape lids. It would also be obvious to anyone skilled in the art that materials used in this apparatus can vary and be configured accordingly for any specific need or use, also the device can be fashioned into a variety of shapes and sizes so as to conform to the shape and size best suited for use with specific cooking vessels without departing from the scope of the invention.

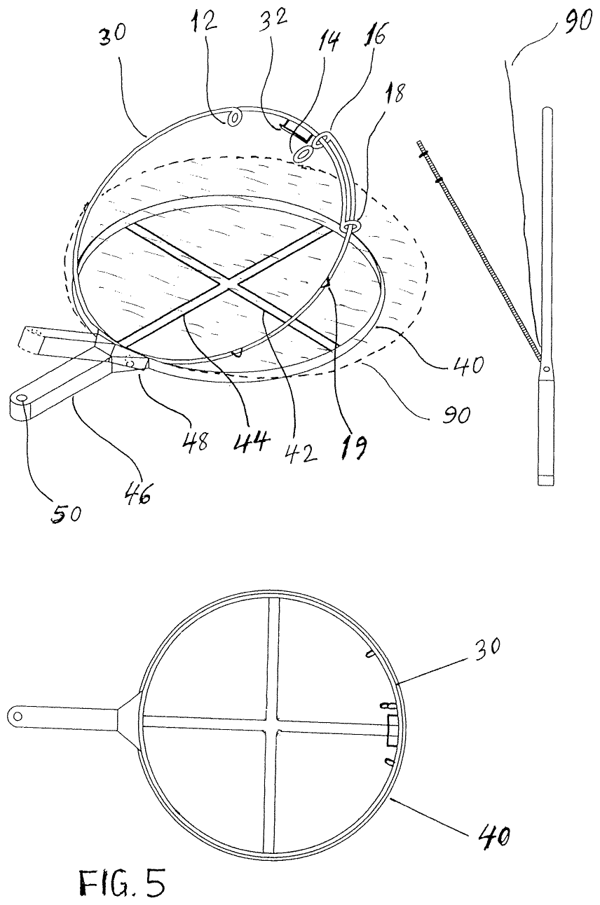

FIG. 5 illustrates another embodiment of a splatter control apparatus. The splatter control apparatus according to the embodiment comprises a flexible tension ring member 30, a frame member 40 with inner side designed to cradle the ring member 30, the ring member 30 is opportunely coupled to the frame member 40 to swing in and out of the frame 40, the ring 30 can compress substantially to manipulate to be secured inside the frame member 40, a flat sheet member 90 is being placed and held between the ring 30 and the frame 40, where the tension ring 30 secures the flat sheet member 90 properly into the frame 40, the ring 30 is generally made of a flexible tension capable material. Protruding means 19 if needed, extend from the ring 30 for extra security while securing the ring member 30 into the frame member 40. The ends 16 and 18 are opportunely coordinated to compress and decompress to manipulate the ring 30 in position into the frame member 40. Protruding means 12 and 14 extend form the ring 30 to manage the compression of the ends 16 and 18 of the ring member 30.

The means 12 and 14 can be coated with a protective insulating material. Further, the ends 16 and 18 of the ring member can be configured to be part of a coupling mechanism to attach the ring to the frame member 40, where the ends 16 and 18 situated in a mechanism to permit the ring ends to shift and slide sideways to compress and decompress the ring member 30 to be manipulated in and out of the frame member 40. The compression mechanism of the ring 30 may employ variable methods to achieve similar compression results without departing from the scope of the invention. Supporting rod or spoke means shown as 42 and 44 added to the frame 40 at proximate predetermined position enables the frame to rest on top edge of variable size and shape cooking vessels where the number of spokes is determined by need. This invention can utilize a proper handle design 46 coupled to the frame for easy handling, the handle 46 can be riveted, hinged or detachable by a proper coupling means. Appropriately, there is an eyelet 50 on the handle 46 for the hanging and storage of the splatter device that is located on the rear end of the handle 46 however this example does not limit other hanging mechanisms or storage options. A lift lever 32 or the like extend of the ring member 30 as needed. This embodiment of splatter control device with its versatility can be modified to be temporarily or permanently coupled to the top edge of a vessel as a substitution of or a complement to the use of a handle to manipulate lifting and moving the apparatus.

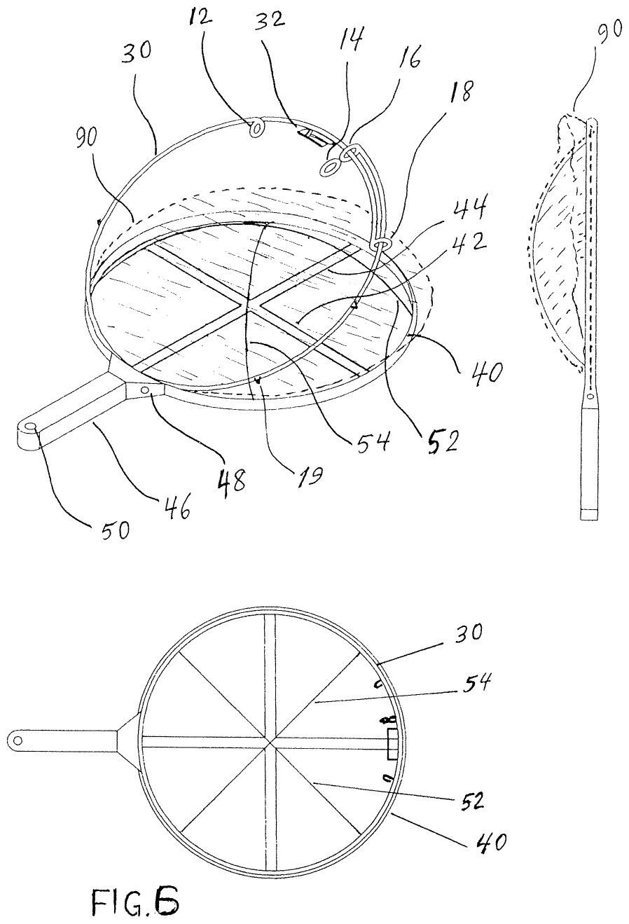

An embodiment of the splatter control apparatus illustrated in FIG. 6 is essentially identical to the splatter control apparatus according to the embodiment in FIG. 5 Two added elements 52 and 54 shown in FIG. 6 or similar structure to create a supplementary volume space on top of the frame member 40, this added structure will create extra cooking space volume for splatter and moisture generated during cooking. All other elements of the embodiment are still applicable and essentially identical to embodiment shown in FIG. 5. Before the cooking process a flat sheet member 90 can be placed over the frame member 40 and the structure created by 52 and 54 and thereafter the ring member 30 closing over the flat sheet 90 and is secured into place inside the frame member 40 FIG. 6. This embodiment can provide a significant safety factor when the cooking liquid or oil is to a high level closer to the rim in the cooking vessel.

This invention concept may easily be modified to accommodate various other applications in the medical, industrial and manufacturing domains.

To demonstrate the effectiveness of the herein described invention, a disposable splatter paper sheet was tested with various embodiments employing a flat sheet and a sleeve members, Fatty foods cooked in a frying pan, the splatter sheet was secured inside a lid according to FIG. 3B of the frying pan and placed over the pan so that the lid was sitting on top of the food being seared, and the food was allowed to sear at a high temperature for several minutes during which time the splatter sheet very effectively prevented any grease from leaving the frying pan yet allowing water vapor to escape and get trapped on the undersurface of the lid without any moisture dripping over the food, as evidenced by the steam condensed and being visible on the undersurface of the lid above the flat sheet however no water vapor drips in the frying pan.

Although sitting directly on top of the searing food, the splatter sheet retained its structural integrity for 40 minutes of continuous use without any moisture drips over the food. The food was fully cooked and well browned to a pleasing level of crispy caramelized results, further demonstrating that the splatter sheet was effective at allowing the moisture to escape so as to allow a relatively high cooking temperature and an effective cooking environment for frying. Similar results were achieved as in FIG. 3A utilizing the sleeve member 85 inside the lid 11, The same demonstration was performed using a flat sheet of paper type with the second embodiment demonstrated in FIG. 4. The demonstration of both embodiments was repeated with searing and deep frying of different foods. The performance of the splatter control apparatus stopped most grease splatter and allowed all the moisture to escape while the moistened sheet and sleeve acting as absorbent of cooking odor.

It is understood that the above-described embodiments are only illustrative of the application of the principles of the present invention. The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

Although the figures illustrate few embodiments with circular shaped apparatus, one skilled in the art would appreciate that the apparatus may be shaped differently to conform to different sized and shaped vessels, according to various embodiments.

It is also envisioned that the flat sheet member 90 may be of variable materials or combination of transparent, fully or partially opaque, porous, non-porous, mesh screen material according to various embodiments. It is expected that there could be numerous variations of the design of this invention and may vary in shape, width, length, size, diameter, thickness and design, variable tension mechanism, usage, function and manner of operation, assembly and use etc. According to alternative embodiments, it is envisioned that the components of the device may be constructed of a variety of available proper materials with no limitations, such as metal, paper, fabric, fiber, wood, bamboo, silicon, plastic, polymer, or a combination thereof.

while the present invention has been described above with particularity and detail in connection with what is presently deemed to be the most practical and preferred embodiments of the invention, it will be apparent to those of ordinary skill in the art that numerous modifications may be adopted. without departing from the principles and concepts of the invention as set forth in the claims.

It should be noted, that it is unprecedented or thought of before to implement the use of spring tension force in the manner in which claimed as part of kitchen accessories.

1. A splatter control apparatus for use with a cooking vessel lid, comprising:
(a) a flexible, elastically deformable tension ring member configured to be compressible for insertion and positioned along an inner side of a frame of a cooking vessel lid; and
(b) an absorbent sleeve member disposed circumferentially about said tension ring member;
wherein the absorbent sleeve member envelops the tension ring member along substantially its entire circumference thereof;
wherein, upon release from compression, the tension ring member provides an outward expansion force by elastic recovery, thereby urging the absorbent sleeve member into continuous circumferential contacting relation with the inner side of the frame of the lid; and
wherein the absorbent sleeve member is positioned along the inner side of the lid to intercept and absorb grease and condensed moisture migrating along an inner surface of the lid during cooking.

2. The splatter control apparatus of claim 1, wherein the absorbent sleeve member is removable and replaceable relative to the tension ring member.

3. The splatter control apparatus of claim 1, wherein the absorbent sleeve member comprises a natural or synthetic absorbent fibrous material selected from paper-based, fabric-based, bamboo-based, cellulose-based, or nonwoven materials.

4. The splatter control apparatus of claim 1, wherein the tension ring member comprises a natural or synthetic resilient material selected from metal, polymer, silicone, plastic, wood, or composite materials.

5. The splatter control apparatus of claim 1, wherein the absorbent sleeve member and the tension ring member are formed of different natural or synthetic materials, wherein the tension ring member is characterized by greater structural rigidity than the absorbent sleeve member.

6. The splatter control apparatus of claim 1, wherein the apparatus is retained against the inner side of the lid without clips, fasteners, rigid flanges, adhesives, or mechanical attachment structures, other than a coupling mechanism configured solely to permit inward and outward swinging movement of the tension ring member relative to the frame and configured to provide no retention or expansion force.

7. The splatter control apparatus of claim 1, wherein the tension ring member includes manipulative features configured to facilitate compression, insertion, and removal.

8. The splatter control apparatus of claim 1, wherein the tension ring member exerts an outward force through the absorbent sleeve member to maintain the absorbent sleeve member safely secured in continuous circumferential contacting relation with the inner side of the lid during cooking.

9. The splatter control apparatus of claim 1, wherein the tension ring member has a closed-loop configuration selected from substantially circular, polygonal, or non-circular geometries, the configuration being elastically conformable to the inner side of the frame of the lid.

10. The splatter control apparatus of claim 1, further comprising a coupling mechanism pivotally connecting the tension ring member to the frame of the lid, wherein the coupling mechanism is configured solely to permit inward and outward swinging movement of the tension ring member relative to the frame, and is devoid of any elastic structures or spring like force for providing outward expanding tension force securing the apparatus against the inner side of the lid.

11. The splatter control apparatus of claim 1, wherein the absorbent member is formed from a flat absorbent sheet member secured around the tension ring member such that at least a portion of the flat absorbent sheet member is positioned between the tension ring member and the inner side of the frame of the lid.

12. A splatter control apparatus for use with a cooking vessel lid, comprising:
an integrated, fully disposable, elastically deformable absorbent member having a closed-loop configuration sized to conform to an inner side of a frame of a cooking vessel lid;
wherein the absorbent member is compressible for insertion and, upon release, self-expands to maintain continuous circumferential contacting relation with the inner side of the lid; and
wherein the absorbent member provides both tension-based securing and absorption of grease and moisture splatter generated during cooking.

13. The splatter control apparatus of claim 12, wherein the absorbent member comprises a composite structure combining a natural or synthetic absorbent material portion and a natural or synthetic resilient tension material portion.

14. The splatter control apparatus of claim 12, wherein the absorbent member is formed as a plurality of pre-measured segments sized to conform to predetermined cooking vessel lid diameters, or is formed as an elongated absorbent member adjustable for installation within a lid.
